(19) United States
(12) Patent Application Publication
(10) Pub. No.: US 2026/0154403 A1
(43) Pub. Date: Jun. 4, 2026

(54) DEEP LEARNING PIPELINE FOR PROACTIVE IDENTIFICATION AND MITIGATION OF COMPUTING SYSTEM ATTACKS FROM SOCIAL ENGINEERING

(71) Applicant: PAYPAL, INC., San Jose, CA (US)

(72) Inventors: Min Bian, Shanghai (CN); Xue Zhang, Shanghai (CN); Shupeng Geng, Shanghai (CN); Lingyi Lu, Palo Alto, CA (US); Yan Zhang, Shanghai (CN); Ming Yuan, Shanghai (CN)

(21) Appl. No.: 18/965,899

(22) Filed: Dec. 2, 2024

(51) Int. Cl. G06F 21/55; G06F 16/34; G06F 40/205

(52) U.S. Cl. CPC G06F 21/554; G06F 16/345; G06F 40/205; G06F 2221/2103

(57) ABSTRACT

Computer security improvements relating to detection of social engineering attacks using a deep learning pipeline for account and communication correlations are disclosed. A service provider may utilize a framework having computing operations for detecting social engineering attacks, fraud, and other malicious or suspicious activities by malicious bots and other fraudsters. In this regard, the service provider may extract pattern data from communications using one or more AI models, which may include semantic information. Account assets for different accounts may be correlated using a relationship graph that links the assets based on the communication patterns shared between the assets. The relationship graph may then be used by additional AI models that classify if the communications are associated with social engineering attacks by classifying the communications using an attack classifier. The classification may be based on inferencing by the AI models from training on past social engineering attacks.

### TECHNICAL FIELD

The present application generally relates to artificial intelligence (AI) systems, and more particularly to a deep learning pipeline for clustering of accounts based on shared features and similar messages for detection and mitigation of social engineering attacks.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. However, as hackers and other malicious users or entities become more sophisticated, they may perform different computing attacks and other malicious conduct to compromise these communications. For example, attacking entities may use scripted bots that replay, potentially many times in quick succession, an attack and/or with different endpoints including employees, internal agents, and other users. One type of such attack is a social engineering attack where fraudsters may use bots and scripts to manipulate humans to trusting the fraudsters and/or divulging sensitive, personal, and/or financial information of themselves or, with online transaction processors and service providers, other customers and users of the service provider.

Without accurately and quickly identifying these attackers and performing remedial actions, the service provider and its users may risk fraud, loss, and other consequences associated with unauthorized exposure of user data or compromised systems. The inability to promptly identify and counter these attacks can lead to substantial financial losses and compromise the integrity of the customer service channels. Intelligent systems for automating fraud detection and prevention continually require more advanced and evolving techniques and solutions. As such, there is need for an effective and proactive automated computing solution to thwart these fraudsters and conserve available resources for legitimate customers.

### BRIEF DESCRIPTION OF THE DRAWINGS

FIG. 1 is a block diagram of a networked system suitable for implementing the processes described herein, according to an embodiment;

FIGS. 2A-2C are exemplary diagrams for use of relationship graphs of account assets and communication patterns for detection of computing attacks performed through communication exchanges, according to an embodiment;

FIGS. 3A and 3B are exemplary user interfaces of communications and trending patterns in communication content that may be used for detection of computing attacks performed through communication exchanges, according to an embodiment;

FIG. 4 is a flowchart for a deep learning pipeline for proactive identification and mitigation of computing system attacks from social engineering, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a deep learning pipeline for proactive identification and mitigation of computing system attacks from social engineering. Systems suitable for practicing methods of the present disclosure are also provided. Note that while various examples, structures, techniques, etc. may be described with respect to a service provider in this specification, these structures, techniques, etc. are generalizable and are applicable to any entity that implements security systems and defenses for computing attack detection and mitigation using machine learning (ML) models, according to various embodiments.

In an entity's (e.g., service provider's) systems, such as online platforms and systems that allow users to interact with, use, and request data processing, the entity may provide a computing architecture that may encounter different types of fraud, account takeovers (ATOs), money laundering, and other malicious and/or unlawful conduct from multiple sources over a network. These sources may correspond to malicious or fraudulent actors and/or their devices, as well as computing bots or other automated processes that may automate computing attacks and fraudulent behavior in unison, quickly, and/or at a high volume. For example, with networked communications for online platforms and systems, service providers may provide computing services to users and other entities through computing architectures. Such provision of services and corresponding computing architectures may be vulnerable to different types of computing attacks coming from malicious users and sources over a network. For example, a malicious actor may initiate a computing attack on the computing environment of the service provider that may compromise services (e.g., electronic transaction processing services) and/or expose data (e.g., personally identifiable information (PII) and/or funding source information) to the malicious actor. Computing attacks may be executed through automated computing bots or operations, such as executable scripts and bots that may quickly repeat computing attacks with different endpoints and/or internal users, employees, agents, and the like, such as in the case of social engineering attacks.

With the advent of LLMs and other generative AI systems, creating scripts, messages, text, emails, and other communications that may be personalized and targeted while generated automatically has become easier, faster, and more sophisticated, leading to more numerous and effective attacks. Shell scripts may also automate other processes and operations, including program or application executables that automate execution of scripts for social engineering attacks. These computing attacks may lead to fraud and loss by the service provider. In particular, social engineering attacks have become a significant concern in the digital age, particularly within customer service channels. These attacks are typically orchestrated by fraudsters who employ deceptive tactics to manipulate customer service systems or agents into approving fraudulent requests or to test the system's vulnerabilities. The advent of advanced artificial intelligence (AI) technologies such as Language Learning Models (LLM) like ChatGPT™ has further exacerbated the situation. These sophisticated models are capable of generating human-like text, making it increasingly challenging to distinguish between genuine customer interactions and fraudulent attempts. Fraudsters are leveraging these technologies to create multiple accounts and mass-produce messages, thereby flooding customer service channels with an overwhelming volume of contact requests. The primary objective of these malefactors is to test the system's vulnerabilities or to get fraudulent requests approved if one of the contact requests slips through the cracks. Bots capable of quickly reproducing these attacks and/or changing messages further creates difficulties with properly addressing these attacks.

To better detect fraud, accounts used by these actors and bots may be correlated based on shared or similar communications and account data. However, this may require specific generation of relationship graphs for accounts and their shared assets, such as data features corresponding to accounts and account data, that may be linked or connected based on similar messages or other communications. As such, an online transaction processor or another online service provider may implement a security and fraud detection system for social engineering attacks, as well as other computing attacks and/or fraud. Conventionally, risk detection systems and models for behavior pattern identification may analyze behaviors of users, accounts, and the like for the current instance of behaviors. For example, a risk model may analyze a transaction and transaction messages, such as communications between parties, which offers limited insight into the parties and potentially fraudulent activity. To address these limitations of conventional systems, a fraud detection system, in one embodiment, may implement a deep learning pipeline that may intelligently generate relationship graphs and utilize graph features and/or embeddings created from those graphs to train ML models, NNs, and the like to identify whether accounts are engaging in social engineering attacks through communications, such as if the communication exhibit patterns associated with social engineering attacks.

A fraud detection system implementing the deep learning pipeline herein may assist in preventing or minimizing these computing attacks and other abuses on a service provider. The deep learning bot detection framework and system may be implemented in a computing architecture and trained to predict, classify, and/or detect if a computing device and/or communications may be used by a malicious actor and correspond to a social engineering attack, including users and scripts executed by those users. As such, the framework may provide an automated fraud detection system that may detect and categorize suspicious social engineering account groups. This pipeline uses deep learning models (e.g., neural networks (NNs) and/or deep NNs (DNNs)) that incorporate customer profiling and behavioral features and employ graph computation for the linkage of account assets and conversations from messages or other communications. The output of the deep learning pipeline may correspond to a tagging and/or grouping of fraudulent accounts and/or communications, thereby enhancing the security of customer service channels.

Upon or after a contact or other communication in a communication channel, such as a help or assistance channel, the bot detection framework may use a natural language processing (NLP) parser, which includes a trained encoder, classifier, and post-processor, to encode and extract the conversation or message. This NLP parser and/or corresponding module may further utilize one or more LLMs for summarization and key information extraction of the communication. The results may be directly used in the subsequent graph building (e.g., by comparing the pairwise message semantic similarity), and may further assist the feature extractor in extracting useful non-NLP information of the accounts. Once the graph is constructed, a classifier may utilize the graph information to classify and cluster the fraudulent groups of accounts based on their shared assets, such as account data features and shared information about the contact, profiles, devices, network and/or IP addresses, and other behavioral information.

Malicious accounts may then be identified and addressed accordingly by implementing fraud prevention measures and executing actions with the account and/or other accounts to limit or minimize fraud and potential or real loss. LLMs may be employed to aid in the creation of coherent and detailed reports, and to extract crucial features of the identified fraud patterns/accounts for display on the dashboard, enabling continuous monitoring of pattern changes. Upon identification of a malicious pattern, the pattern's data may be used to train models for identification and expansion of this pattern. This allows for the potential identification of fraudulent accounts even if they have not yet initiated an attack.

This proactive approach enhances the overall security of the customer service channels, ensuring a safer environment for users. As such, the framework may provide a holistic approach to combating social engineering attacks by integrating customer behavior, profile, assets, and conversation information and utilizing advanced technologies such as NLP, LLMs, graph computing, and other ML techniques. The deep learning pipeline therefore enables precise tagging of the social engineering attack and generates explainable output in the form of graphs, charts, and dashboards. Further, the framework may provide real-time tracking of attack trends, offering a dynamic and responsive solution that is not commonly found in existing systems.

As such, a deep learning pipeline and framework may employ a deep learning model trained on identified patterns that allows for the proactive identification of potential accounts even before an attack is initiated. This preemptive approach, which provides fast and preemptive fraud detection, significantly departs from the conventional reactive methods. As such, the deep learning pipeline may provide faster and more accurate fraud detection for ongoing social engineering and other computing attacks having specific behavior patterns, while also implementing a proactive and preemptive identification of fraudulent accounts and other account characteristics. By encoding data into relationship graphs and clustering accounts, accurate inferences may be performed in a more efficient manner for large datasets. The pipeline may provide fraud detection through recognizing fraud intention from semantic analysis, which is a pioneering application of NLP for social engineering/fraud detection attack identification. This use and improvement of technology underscores the improvements provided to the technical problems with identification of computing attacks that use and leverage social engineering, thereby improving the manner in which social engineering attacks are detected and prevented.

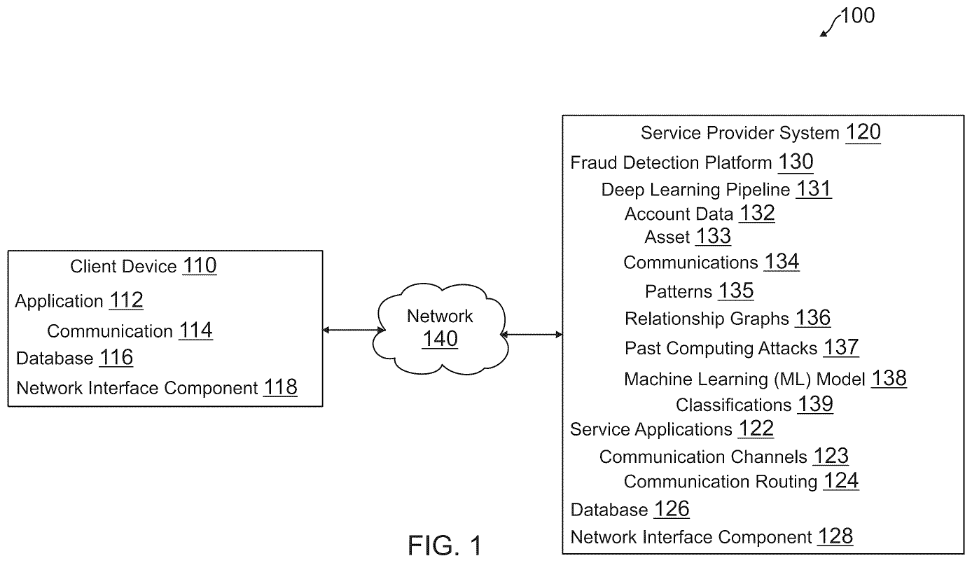

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider system 120 in communication over a network 140. Client device 110 may be utilized by a user, such as a customer of service provider system 120, to engage in activities with other computing devices, servers, and systems over network 140, including those associated with communications in one or more communication channels, such as a service channel or assistance channel. Service provider system 120 may provide various data, operations, and other functions over network 140 to provide services to client device 110 and/or other devices of users, which may include electronic transaction processing. In this regard, client device 110 may utilize an account to engage in communications, which may be processed by service provider system 120 to identify fraud and other illegal, illicit, or unauthorized activities that may be associated with social engineering attacks or other computing attacks.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of a customer, fraudulent actor, and/or other user associated with service provider system 120. Client device 110 may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 140, which may include accessing and/or interacting with service provider system 120, for example, to process a transaction, payment, or transfer. In this regard, application 112 may correspond to a software application, browser, or the like that may utilized by a user of client device 110 to access a website or user interface provided by service provider system 120 and engage in one or more activities including transmission of a communication 114 that may be analyzed by service provider system 120 for potential use in and/or associated with a social engineering attack or other computing attack. As such, application 112 may be used to provide, engage in, and/or transmit communication 114 via one or more communication, messaging, service, or other channels of service provider system 120. Communication 114 may be associated with one or more accounts accessed and/or used through application 112 and may therefore be linked to an account, which may have corresponding account data include assets and/or other data features from account use.

Communication 114 may include content, such as a message including text, media (e.g., audio, video, image, etc.), and/or other information associated with actions, behaviors, interactions, and the like performed with or using an account. In some embodiments, communication 114 may include and/or be associated with contact information, a financial account number, a user identification, a device identifier, or other information. Communication 114 may be stored with account data, which may be processed by service provider system 120, as discussed herein. When using application 112, a bad actor may utilize application 112 and/or engage in communication 114 to conduct fraud via a social engineering attack or other computing attack. As such, service provider system 120 may process communication 114 for identification of fraud through linking communication 114 and/or the corresponding account assets and other features of account data using a deep learning pipeline trained as discussed herein. However, where client device 110 is not used by a bad actor, a valid user may also use application 112 and engage in transaction processing, and communication 114 may be nonfraudulent and authorized using the same or similar ML clustering model.

To provide communication 114, application 112 may interact with service provider system 120, such as through interfacing with communication channels, applications, services, agents, and/or bots corresponding to service applications 122 through one or more application programming interfaces (APIs) and/or API calls that may be exchanged including requests and responses. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information (e.g., a website for a merchant), presenting the website information to the user, and/or communicating information to the website including navigating between webpages to login to accounts, process transactions, and/or otherwise utilize computing services.

However, in other embodiments, application 112 may include a dedicated software application of service provider system 120 or other entity (e.g., a merchant) resident on client device 110 (e.g., a mobile application on a mobile device), which may be configured to view and utilize data via user interfaces (e.g., applications interfaces displayable by a graphical user interface (GUI) associated with application 112) and request execution of computing operations when utilizing accounts with service provider system 120. Thus, application 112 may provide one or more of user interfaces, for example, via GUIs presented using an output display device of client device 110, to enable the user associated with client device 110 to utilize computing services, platforms, and applications of service provider server with accounts, which may request execution of computing operations through user interface commands and other user inputs.

Application 112 may provide transaction processing, such as through a user interface enabling the user to enter and/or view a transaction for processing. This may be based on a transaction generated by application 112 using a service provider platform or website, merchant marketplace, or by performing peer-to-peer transfers and payments via service provider system 120 in conjunction with another account and/or computing device, which may link accounts and/or account data in a network of users. Application 112 may access accounts and view and/or utilize account information, user financial information, and/or transaction histories. In some embodiments, different services may be provided by service provider system 120 via application 112 including social networking, messaging, media posting or sharing, microblogging, data browsing and searching, online shopping, and other services available through service provider system 120. Thus, application 112 may also correspond to different service applications and the like that are associated with service provider system 120.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, websites, and the like. Service provider system 120 may provide computing services to various entities, which may implement security and fraud detection and prevention systems using a deep learning pipeline. These fraud detection processes may utilize relationship graphs of account assets that may be correlated based on the same or similar communications and communication content, where a deep learning pipeline may identify accounts engaged in the same or similar behavior. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes a fraud detection platform 130, service applications 122, a database 126, and a network interface component 128. Service applications 122 and/or fraud detection platform 130 may correspond to executable processes, platforms, applications, and/or associated content and data with corresponding hardware. In other embodiments, service provider system 120 may include additional or different applications, platforms, and modules having corresponding hardware and/or software as required by their corresponding embodiments.

Fraud detection platform 130 may correspond to one or more processes to execute modules and associated specialized hardware of service provider system 120 to provide a deep learning pipeline 131 that may be used to detect fraudulent behavior and/or computing attacks based on similarities in communication patterns and content patterns for accounts and shared account assets or other features. In some embodiments, fraud detection platform 130 may correspond to specialized hardware and/or software used for training and/or implementing ML models including NNs and other deep learning models for identification of behavior and communication patterns that indicate computing attacks. In this regard, deep learning pipeline 131 may be used to perform inferencing and/or account clustering for detection of account and/or communication similarities using the processes described herein, for example, to utilize fraud detection services provided by service provider system 120.

Initially, fraud detection platform 130 may execute deep learning pipeline 131 and/or receive account data 132, which may include different messages, calls, or other communications 134 (e.g., communication 114 from client device 110), for purposes of ML model training and/or account clustering according to their relationship graphs. To provide more optimized and accurate model training and detection of communication patterns and account relationships, deep learning pipeline 131 may utilize relationship graphs for graphing and/or representing relationships of communications 134 to assets 133 from account data 132 based on patterns 135. Assets 133 may correspond to different data features for of a computing device identifier, a network address, user information, financial information, an activity or user history, or other assets and information that may be used by, with, or in association with an account and/or otherwise be correlated with the account. In this regard, assets 133 may be shared by multiple accounts engaged in a computing attack but may also be shared by related accounts that may be valid and/or engaged in lawful and/or authorized communications and activities. Assets 133 may be identified by asset identifiers, where the asset identifiers may be used when processing assets 133 by deep learning pipeline 131.

Deep learning pipeline 131 may parse account data 132 to determine the accounts and corresponding account data that are linked or connected between accounts and/or between the different types of account data. For example, a phone number may be shared between or associated with multiple accounts, or an email address may be shared or associated with the same or different accounts. As such, assets 133 may include data representing the links or connections between accounts and account data, such as by identifying the account and/or account data and a shared connection. For example, a phone number, credit card, email, national identity card or NID (e.g., a driver's license, passport, etc.), bank account, etc., may correspond to assets 133, as well as more general data including a virtual identifier, a device identifier, or a domain identifier associated with the contact information or the financial account number. As such, assets 133 may be associated with asset identifiers that identify the corresponding asset and/or asset data.

Communications 134 may correspond to messages, such as emails, text messages, instant messages, chats, voice and/or video calls, and the like that may be exchanged between one or more users and/or accounts. In this regard, generally communications 134 may be used between valid users and/or for lawful or authorized purposes. However, certain ones of communications 134, such as a subset of communications 134 from certain accounts, may be used for malicious and/or fraudulent purposes. These may include use of different ones of communications 134 during a social engineering attack or other computing attack that may attempt to compromise systems and/or users through transmission of the communications and/or content of the communications (e.g., message content or text, payload, etc.). For example, with a social engineering attack, content in communications 134 may attempt to get an internal agent or other user to provide, reveal, or give up sensitive information, navigate to an untrusted or compromised domain or address where fraud may be conducted, or perform some other activity. Communications 134 may be exchanged, transmitted, and/or received in a communication channel, such as a digital channel for email, text messaging, instant messaging, chat, voice/video calls (e.g., phone networks, VoIP, etc.), or the like. Such channels may be provided for different computing services including help or assistance, purchasing, account servicing, financial transactions, etc.

As such, patterns 135 in communications 134 may be used to identify fraudulent and/or non-fraudulent or valid communications, content, and activity. Patterns 135 may correspond to semantic or other linguistic characteristics and analysis of communications 134 to identify the same or similar content, purpose of the content, message, and/or user/group of users transmitting the communication/content. Patterns 135 may be extracted from communications 134 using an NLP parser, LLM, or other language processor of ML models 138 for deep learning pipeline 131. In this regard, an NLP parser may include an encoder, classifier, and/or post-processor that may extract and encode content including text, media, and the like, encode the content, and provide the encoded content for pattern analysis. For example, words, phrases, and the like may be parsed, and data may be extracted including semantic information for and/or used to determine context, purpose, and the like of communications 134. In some embodiments, this may include use of an LLM or the like of ML models 138 for summarization and/or key word or information extraction. The resulting data for patterns 135 may be used in graph building (e.g., for comparing the pairwise message semantic similarity) of relationship graphs 136. Patterns 135 may include pattern data of communications and/or communication content based on semantic information (e.g., semantic characteristic, semantic similarities, etc.) extracted from the content in communications 134. Patterns 135 may include a context and/or a purpose of communications 134 and may have a same context or a same purpose that may overlap in different ones of communications 134 based on the same or similar use of words or phrases that may match or be correlated between content in communications 134.

Using assets 133 and patterns 135, deep learning pipeline 131 may generate relationship graphs 136. Relationship graphs 136 may correspond to a graph, represented in a two or three-dimensional space, of assets 133 linked by patterns 135 or other data for communications 134. As such, relationship graphs 136 may correspond to social graphs or other visual representations of asset identifiers for assets 133 for accounts and account data (each represented as the corresponding data and type of data) as nodes. Connections between the asset identifiers for assets 133 may be represented as edges connecting the nodes for assets 133. As such, relationship graphs 136 may correspond to a diagram of how assets 133, identified and/or represented by asset identifiers, are connected by communications 134. Graph embeddings may be generated, which may be used for training an ML models 138 that may be used for inferencing and predicting behaviors, patterns, activities, and/or affiliations (e.g., relationships to others) of accounts, such as engagement in a social engineering attack or other computing attack through communications in a communication channel. Past computing attacks 137 may be associated with communications and/or accounts that perpetrated the attacks, and may be used to draw correlations and/or compare relationship graphs 136 for accounts and communications being analyzed to fraudulent or malicious accounts/communications associated with past computing attacks 137.

As such, ML models 138 may be used to infer or predict whether an account and/or activity of the account is engaging in a computing attack or fraud based on their relationships to other communications and/or accounts transmitting the communications, as well as past computing attacks 137. Graph embeddings may be generated using a graph embedding process, which may embed information networks, such as relationship graphs 136, into lower dimensional vector spaces for ML operations (e.g., by reducing large networks of high dimensionality to vectors in a lower dimensional vector space). Relationship graphs 136 and/or their graph embeddings may be used for inferencing, such as when one or more of ML models 138 have been trained for classifications 139 of accounts and/or communications based on past computing attacks 137. In this regard, classifications 139 may correspond to an attack classifier configured to classify communications and/or accounts transmitting the communications (or likely to transmit the communications) as fraudulent, engaging in a computing attack or malicious behavior, or likely to do so and/or be associated with such behavior. As such, relationship graphs 136 may be used to determine classifications 139 (e.g., ML models 138 trained based on past computing attacks 137) for different accounts and/or communications in real-time and/or during fraud detection.

Further, data scientists and other model training teams may train ML models 138 for fraud detection platform 130 using relationship graphs 136 and/or their graph embeddings for classifications 139 with past computing attacks 137. Fraud detection platform 130 may include and/or train different types of ML models including neural networks (NNs) and deep NNs (DNNs), large language models (LLMs) or other generative AIs, tree-based and other types of ML models, the like. Relationship graphs 136 and/or their graph embeddings may be used as input and/or feature data for features when training and/or inferencing using other types of ML models. For training ML models 138, models may be generated using training data, such as relationship graphs 136 and/or their graph embeddings, which may further be associated with information and/or metadata for the corresponding accounts including annotations or identification of fraudsters and the like for identification of particular communications, behaviors, activities, identification or the like. With ML clustering models trained for classifications 139, an ML clustering algorithm and/or technique may be applied to determine a number of clusters, cluster membership or representation, cluster centroids, cluster size and/or distance from a cluster centroid, and the like. Clusters may be generated and used to train and configure one or more of ML models 138 based on the corresponding shared characteristics, behaviors, identifications, activities, and/or other information or metadata for the relationship graphs.

With other types of ML models, layers, branches, neurons, and the like may be trained using a corresponding training algorithm and/or technique. Layers, branches, clusters, or the like may be trained for inferencing and predictive tasks or inferencing tasks associated with shared information, such as by predicting whether a communication or account is likely engaged in a computing account. For example, ML models 138 may be used for risk assessment and/or fraud detection/prevention, such as by detecting if an account may be linked to or exhibit behavior similar to fraudulent or malicious communications and/or accounts and therefore should be prevented from engaging in certain communications and/or have the communications routed accordingly. In this regard, classifications 139 may correspond to an attack classifier or fraud classifier associated with a fraud detection score or assessment that may be generated based on relationship graph 136. The score may be associated with a threshold similarity, and if the score meets or exceeds a threshold similarity, the classifications 139 may correspondingly classify the communication and/or account. Classifications 139 may be used by service applications 122 for handling of communications 134 in different channels and/or with different users or endpoints.

Service applications 122 may correspond to one or more processes to execute modules and associated specialized hardware of service provider system 120 to process a transaction and/or provide other computing services to users. For example, service applications 122 may be used to process payments and other services to one or more users, merchants, and/or other entities for transactions, where use of those services, applications, websites, data, and the like may include use of ML models 138 for predictive inferencing and/or other outputs including fraud detection and/or computing attack mitigation. In this regard, users, including merchants and other entities, as well as customers and individual users, may establish a digital account for engagement with the products and services of service provider system 120. For example, the account may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

In further embodiments, service applications 122 may provide different computing services to users and entities, including social networking, microblogging, media sharing, messaging, business and consumer platforms, etc. Use of the computing services may require use of certain AI systems, such as those for fraud detection and/or risk assessment including computing attack detection and/or mitigation that may occur through communication 134 transmitted, exchanged, and/or received through communications channels 123 (e.g., browser-based or application chats, email, messaging, voice/video, etc.). Communication channels 23 may correspond to digital processes and data transmission channels for communication of data between users and/or endpoints. To properly route communications 134 to endpoints, communication routing 124 may be used, which may further be integrated with and/or utilize fraud detection platform 130 for detection of computing attacks and mitigation of those attacks through routing malicious or fraudulent communications appropriately.

As such, service applications 122 may be integrated with fraud detection platform 130 for use and/or deployment of ML models 138 once trained. For example, accounts may utilize service applications 122 to engage in different account activities, such as electronic transaction processing requests. Communications 134 may be exchanged during transaction processing, as well as for service, assistance, or the like. Relationship graphs 136 for accounts and communications may be determined and classified using classifications 139 of ML models 138. Thereafter, fraud or other classification scores may be determined and communication routing 124 may be performed to properly route valid and/or fraudulent/malicious communications. Communication routing 124 may include routing communications 134 to a recipient endpoint for a live agent, user or chatbot, terminating a conversation in communication channels 123 and/or with a live agent or chatbot, or outputting alert of malicious/fraudulent ones of communications 134 and/or patterns 135 or other trends in communications 134 being used for fraud or computing attacks.

Service applications 122 may also provide additional features to service provider system 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 140.

Additionally, service provider system 120 includes or may access database 126. Database 126 may store various identifiers associated with client device 110, as well as account data, including payment instruments, financial information, account balances, and authentication credentials, as well as transaction processing histories and data for processed transactions. Database 126 may include information for accounts including account data 132, as well as communications 134 exchanged between users and/or accounts. Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

Service provider system 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

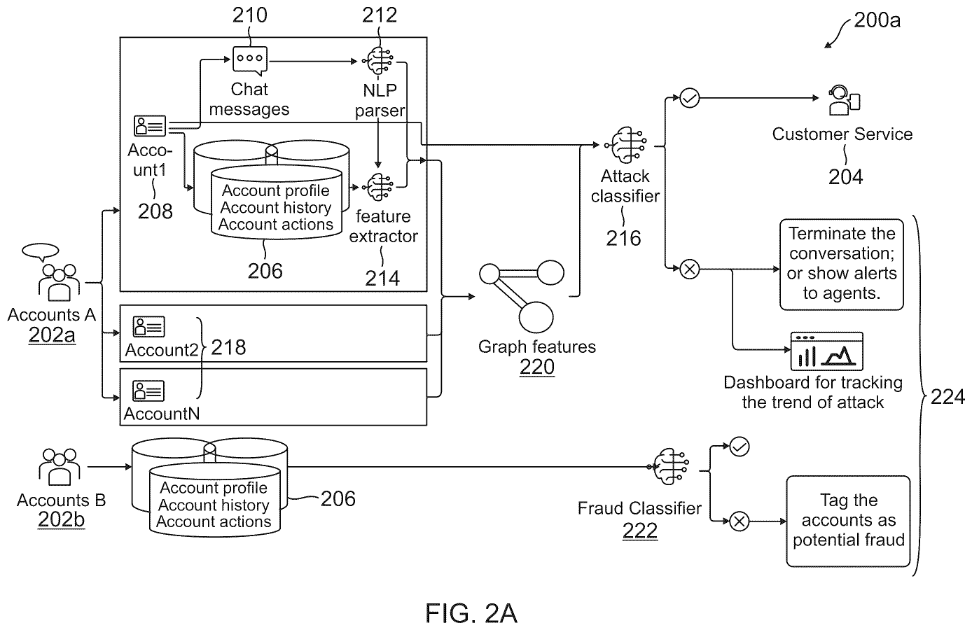

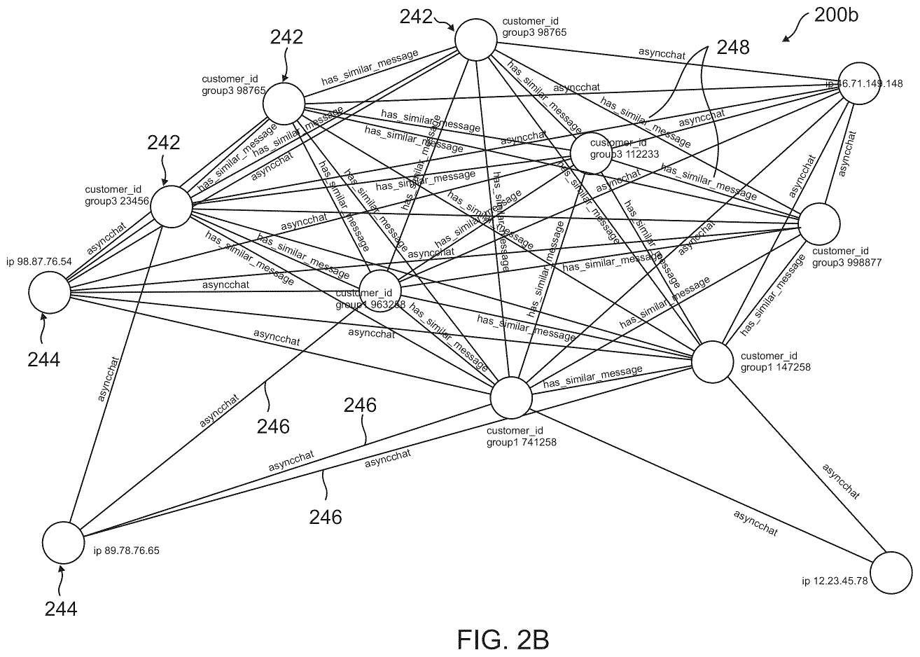

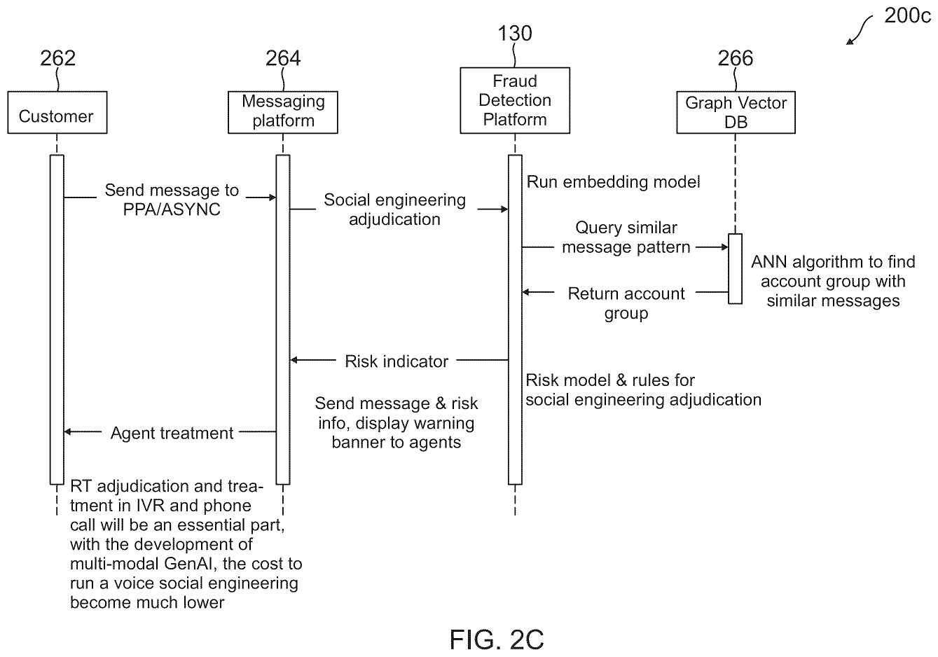

FIGS. 2A-2C are exemplary diagrams 200a-200c for use of relationship graphs of account assets and communication patterns for detection of computing attacks performed through communication exchanges, according to an embodiment. Diagram 200a shows representations of the components, data, and calls of deep learning pipeline 131 of fraud detection platform 130 for service provider system 120, discussed in reference to system 100 of FIG. 1. In this regard, a system shown in diagram 200a may be used to process a relationship graph shown in diagram 200b when exchanging and processing the calls shown in diagram 200c to process communications for mitigation of computing attacks.

In diagram 200a of FIG. 2A, accounts 202a and 202b may be analyzed for fraud, computing attacks (e.g., social engineering attacks), and the like that may be committed or perpetrated through communications exchanged between those accounts. In this regard, accounts 202a and 202b may communicate, or may be capable of communication at a future time, with a customer service 204 to perpetrate such computing attacks and/or fraud. Consequently, account data 206 may be analyzed for accounts 202a and 202b with different communications exchanged to identify if a computing attack is being performed, or if one or more of the accounts is likely to commit such attack, is affiliated with other accounts committing the attack, or otherwise associated with the attack such that blocking or banning the account may mitigate a computing attack, risk, fraud, and/or loss.

In this regard, an account 1 208 from accounts A 202a may engage in chat messages 210 with customer service 204. Chat messages 210 may be live and synchronous chats, or may be asynchronous, such as an offline chat or messaging. An NLP parser 212 may parse the content of chat messages 210 and/or other communications of account 1 208 to extract context and/or purpose data for the content, such as one or more patterns in the content that may be correlated with other contents. An LLM may be used as well for summarization and/or key word or key information extraction and determination, which may be used in pattern identification and/or analysis. Account data 206 may undergo feature extraction using a feature extractor 214, such as a data parser, extractor, or the like that may convert tabular data or time-series data to ML features for ML model processing. As such, feature extractor 214 may correspond to an extraction process for one or more ML models based on the features to be processed, which may extract and/or convert data to a feature form and/or format for features to be processed by the model(s).

The data for account 1 208, including the extracted information from account data 206 and/or chat messages 210, may be provided to an attack classifier 216 for classification of whether chat messages 210 are malicious and/or correspond to a computing attack. In this regard, attack classifier 216 may correspond to an ML model, such as an adaptive learning model, trained for classification of communications and/or communication content for computing attack identification and/or prediction. Attack classifier 216 may therefore provide ML inferencing for computing attack classification including social engineering attack classification. Further, account 1 208 may be processed with additional accounts 218 for generation of graph features 220 that may be used to train attack classifier 216. Graph features 220 may be extracted and/or embedded (e.g., using a graph embedding process) from relationship graphs generated using communication patterns and account data assets, as shown in diagram 200b below.

Generation of the relationship graphs may be performed using user, device, entity, account, network address, financial or any other identity/identification data. This data may correspond to account data assets, such as a phone number, credit card, email, national identity card or identifier (e.g., a driver's license, passport, etc.), bank account, a virtual identity/identifier, a device identifier, an IP address, financial data, PII, known your customer (KYC) data, and the like. Relationship graphs may include these data assets as nodes that may be linked by edges representing shared communication patterns, such as asynchronous communications, similar messages, similar message sentences or statements, message context/purpose similarities or overlap, and the like. Graph features 220 may be determined by embedding the relationship graphs using a graph embedding process, and attack classifier 216 may be trained using an ML algorithm or training technique, which may include adaptive learning DNNs and other deep learning algorithms.

Chat messages 210 may be routed based on an output from attack classifier 216. Where chat messages 210 are not classified as a computing attack, such as if chat messages 210 are valid or approved, customer service 204 may receive chat messages 210 for handling and/or response. However, if a computing attack is classified and/or predicted by attack classifier 216, attack mitigation actions 224 may be taken. Attack mitigation actions 224 may include terminating the conversation and/or showing an alert to an agent, adding chat messages 210 and/or their patterns or content to a dashboard for tracking the trend of the attack, or performing another action to mitigate the attack including notifying security systems, banning accounts or blocking communications, and the like. Attack classifier 216 may also be used with accounts B 202b to proactively determine if any accounts may be likely to engage in computing attacks, and therefore should be banned, monitored, tagged as potentially fraudulent, or have an identification challenge issued to one or more of accounts B 202b using attack mitigation actions 224. For example, an identification challenge may require a user to provide identification or verification information or complete a challenge-response test to detect if the account is being used by a human user. A challenge-response test may correspond to a CAPTCHA test or the like configured to detect human users from bots.

In diagram 200b of FIG. 2B, a relationship graph is shown, which may correspond to one of relationship graphs 136 based on assets 133 shared between accounts and/or correlated based on patterns 135. As such, the nodes in the relationship graph in diagram 200b may be determined based on assets 133 from account data 132, which may be connected by patterns 135 extracted from communications 134. Assets 133 may be analyzed to determine one or more of communications 134 that may link those assets, such as if a communication was sent or exchanged between customer identifiers (IDs) 242, such as account IDs for accounts of customers, that have a corresponding communication pattern. Assets 133 may also include IP addresses 244 that may have corresponding communications exchanged, and therefore patterns to those communications that may link IP addresses. As such, customer IDs 242 and IP addresses 244 may correspond to different account assets of accounts.

In the relationship graph of diagram 200b, nodes for customer IDs 242 and IP addresses 244 may be linked by the patterns identified in and/or extracted from the communications exchanged between those account assets. An asynchronous chat pattern 246 may be determined from the type of communications sent between those account assets. As such, one of IP addresses 244 can be seen as exchanging communications with one of customer IDs 242 that has a communication pattern for asynchronous chat pattern 246. Similarly with a similar message pattern 248, different ones of customer IDs 242 and/or IP addresses 244 may be linked by having a similar message pattern between the messages exchanged. The relationship graph may therefore be used to represent the connections and correlations that different account assets have based on shared communication patterns. The relationship graph may then be used to determine accounts and/or communications from accounts that may be associated with computing attacks by correlating further accounts and/or communications with the relationship graph, and specifically the account assets and communications flagged for review, performance of a computing attack, and/or other malicious or fraudulent activity.

In diagram 200c of FIG. 2C, calls are exchanged between different endpoints for users, platforms, databases, and/or other systems that may be communicating through one or more communication channels. A customer 262 may initially send a message in a communication channel, which may correspond to a live chat or conversation channel or an asynchronous channel (e.g., email, text, etc.). A messaging platform 264 may provide the communication channel and may be used by customer 262 to communicate with internal users, agents, chatbots, or the like. In this regard, messaging platform 264 may correspond to a service or assistance platform and communication channel to request assistance or information from live agent or chatbot but may also be utilized for other communications with the service provider's internal users and/or computing bots. As such, where customer 262 may be a malicious party involved in a computing attack, the message or other communications exchanged may be analyzed to mitigate the computing attack, as discussed herein.

In this regard, messaging platform 264 may communicate with fraud detection platform 130 to request an adjudication of whether the message(s) from customer 262 correspond to a computing attack. Fraud detection platform 130 may run an embedding model and/or other AI models to extracted embeddings from the text or other content of the message(s) for analysis. The embeddings may correspond to vectors determined from NLP and/or other text analysis of the content and may be used to determine if similar message patterns can be identified and correlated to computing attacks. Fraud detection platform 130 may query for similar message patterns from a graph vector database 266, which may utilize the patterns with one or more relationship graphs to identify one or more account groups with similar messages. An artificial neural network (ANN) algorithm and/or model may be used for identifying the account group using the relationship graph.

Graph vector database 266 may return an account group to fraud detection platform 130, which may utilize the account group for risk analysis and/or social engineering adjudication of the message(s) from customer 262. One or more ML models, such as an adaptive learning DNN of deep learning pipeline 131, may be used to perform the risk analysis and/or adjudication. A risk indicator may be provided to messaging platform 264 from fraud detection platform 130, where the risk indicator provides an indication of whether the messages are associated with fraud, risk, or social engineering attacks. As such, an alert may be provided if risk is identified, or the messages may be approved and/or indicated as valid/verified. Messaging platform 264 may then respond to customer 262 with an agent treatment of the messages and other communications, such as by ending communications if risk is detected, providing assistance if the messages are valid or verified, routing the messages to another endpoint for flagging or abuse processing, and/or determining trends in computing attacks based on message content.

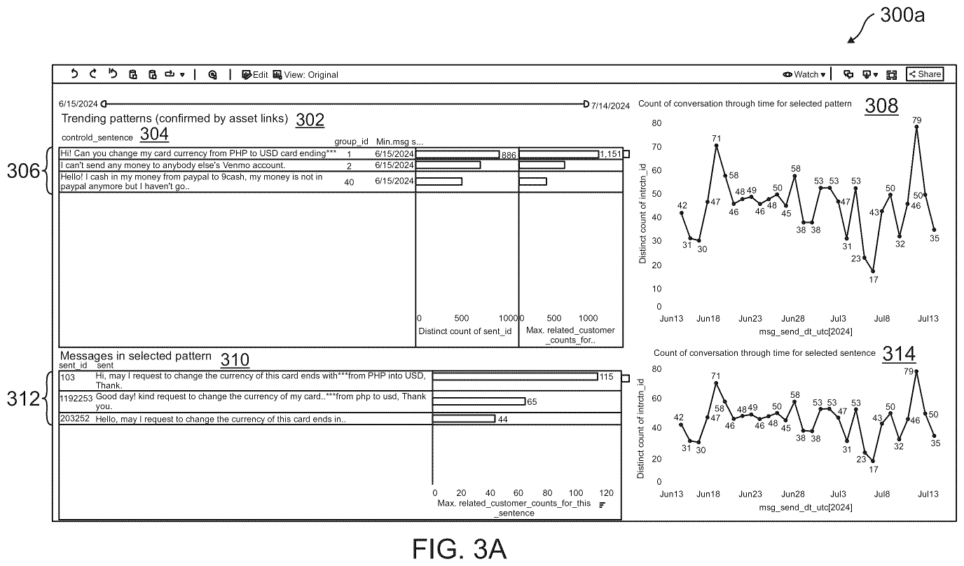

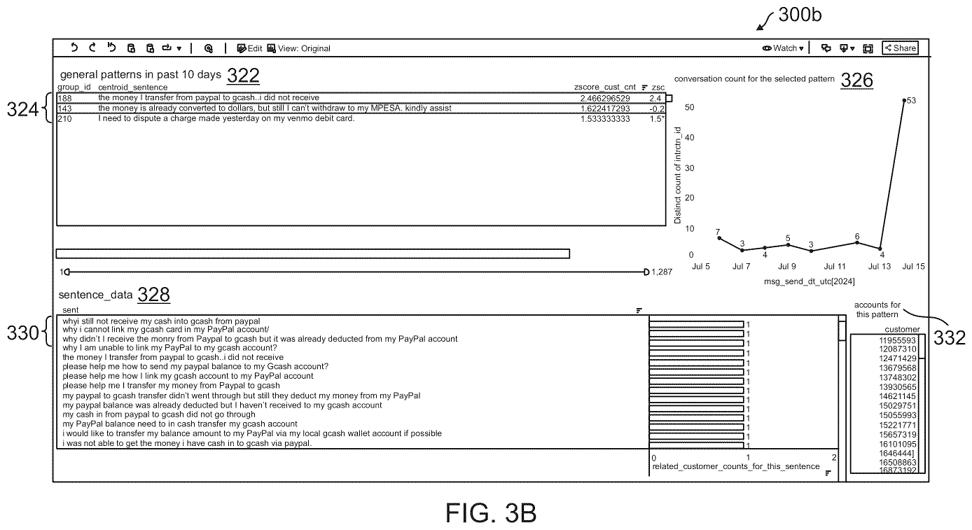

FIGS. 3A and 3B are exemplary user interfaces (UIs) 300a and 300b of communications and trending patterns in communication content that may be used for detection of computing attacks performed through communication exchanges, according to an embodiment. UIs 300a and 300b of FIGS. 3A and 3B include patterns in communications that may be extracted and displayed for account review and analysis, which may be executed by deep learning pipeline 131 of fraud detection platform 130 for service provider system 120, discussed in reference to system 100 of FIG. 1. As such, UIs 300a and 300b may present data to a user that may be used when analyzing computing attacks, such as social engineering attacks, to identify accounts perpetrating the computing attacks and/or identify patterns and trends in communications and communication or message content for proactive identification and mitigation of future attacks.

In UI 300a of FIG. 3A, a user may view trending patterns 302 for centroid sentences 304 extracted from different communications exchanged in one or more communication channels of a service provider. The communications may include those exchanged between different users, as well as with automated endpoints such as computing bots, LLMs, generative Ais, search engines, and the like. Centroid sentences 304 of trending patterns 302 may be identified using NLP and/or an LLM to analyze semantics and context of natural language statements, phrases, and the like. Centroid sentences 304 may correspond to sentences in common and/or acting as the center concept, purposes, and/or context of the communications. Sentence examples 306 of centroid sentences 304 may include different examples of such centroid sentences as extracted from different communications.

Sentence examples 306 of centroid sentences 304 may be displayed to the user to allow for review of the text and information in centroid sentences 304. A user may select from sentence examples 306 to view a usage graph 308 of the sentence over time in different communications sent. As such, the user may view how problematic or social engineering attack sentences may be used in different communications, and how those sentences are used over time, such as a pattern to computing attacks. After selection of one of sentence examples 306 and display of usage graph 308, messages 310 may be displayed for the corresponding content, messages, or other communications that include the corresponding one of centroid sentences 304 that has been selected from sentence examples 306. A user may view and select from message examples 312 to view the communication having the centroid sentence, as well as other communications in a chain or series that have been exchanged.

In UI 300b of FIG. 3B, patterns over time 322 may display different sentences that may be identified from centroid sentences 304 over a time period, such as the last 10 day. In this regard, patterns over time 322 may show patterns that have been identified as occurring at or over a threshold amount, increase, or change (either upward or downward) in occurrence over a time period. Pattern examples 324 may allow a user to view the centroid sentences for each pattern, as well as select from those patterns to view additional data. Pattern examples 324 may therefore include centroid sentences 304 ranked or ordered based on their patterns and/or changes in their patterns over a time period.

In this regard, selection from pattern examples 324 may allow a use to view a conversation count graph 326 shown a count of conversations having the selected one of pattern examples 324 over time. In UI 300b, it can be seen that there is a large spike in the selected on of pattern examples 324 on a date, potentially indicating a computing attack. Sentence data 328 may allow a user to view additional information for the sentences having the selected one of pattern examples 324. For example, sentence data 328 may include communications 330 that include that pattern selected, and communications 330 may allow for review of why the pattern may have changed and/or increased in time (e.g., due to a computing attack or a valid reason, such as an event that may cause communications to be sent that include the pattern). Accounts 332 includes account identifiers or other information for accounts that exchanged communications associated with the selected pattern. As such, accounts 332 may provide a user with more detailed information regarding the accounts involved in computing attacks or other communications for account analysis and further competing attack identification.

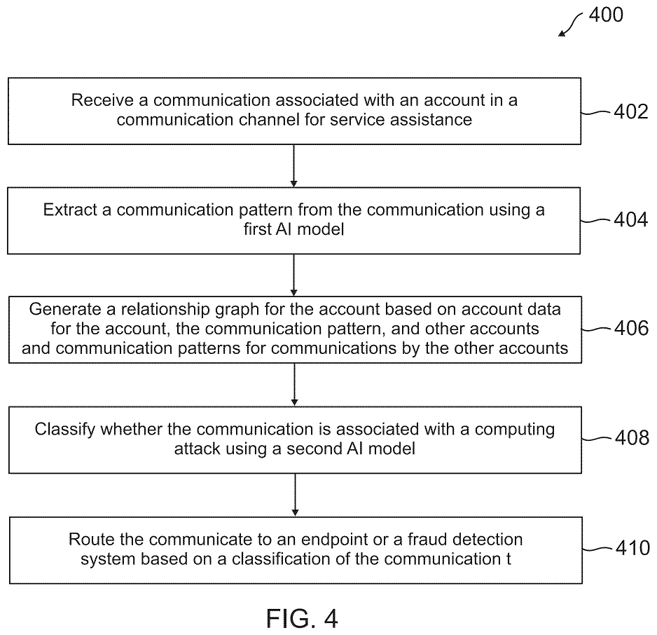

FIG. 4 is a flowchart 400 for a deep learning pipeline for proactive identification and mitigation of computing system attacks from social engineering, according to an embodiment. Note that one or more steps, processes, and methods described herein of flowchart 400 may be omitted, performed in a different sequence, or combined as desired or appropriate.

At step 402 of flowchart 400, a communication associated with an account in a communication channel for service assistance is received. Service provider system 120 may receive one or more of communications 134 in one or more of communication channels 123, which may route the communication(s) to endpoints including users, chatbots, and the like using communication routing 124. However, communication routing 124 may require risk and/or fraud analysis and detection, such as to prevent or mitigate computing attacks including social engineering attacks performed through communications that may have scripted and/or AI generated text and message content. In this regard, communications 134 may have content that includes patterns for different words, phrases, and the like, and such patterns may be analyzed for context and/or purpose of communications 134, as well as recurring words and/or phrases that may indicate the same or similar origin, purpose, and/or context. The recurring words or recurring phrases may be generated by a generative AI, such as an LLM, based on a prompt from the same user (e.g., a malicious party), or the generative AI may generate messages having the same purpose and/or context. As such, semantic analysis of communications 134 may be required.

At step 404, a communication pattern from the communication is extracted using a first AI model. An NLP parser of ML models 138 may be used to extract patterns 135 from communications 134, such as by extracting and encoding content in communications 134 into patterns 135 based on semantic analysis and/or other semantic information in the messages or other content. As such, NLP may be used to determine patterns from semantic analysis of the words, phrases, and the like in the content of the communications. This allows for identification of a purpose and/or context of each of communications 134, which may indicate their corresponding patterns. In some embodiments, an LLM may be used to perform summarization of the content from communications 134, as well as key word or key information extraction and determination, such that the summarized content and/or key information may be used for pattern analysis and extraction.

At step 406, a relationship graph for the account is generated. based on account data for the account, the communication pattern, and other accounts and communication patterns for communications by the other accounts. Relationship graphs 136 for accounts and communications may represent relationships between different types of account data and their assets or other data features, as well as the connections of those assets based on communications and/or communications patterns that may be shared. Relationship graphs 136 may be accessed from a database and/or determined using account data 132 based on assets 133, as well as patterns 135 for communications 134. In this regard, relationship graphs 136 may correspond to a network and/or other representation of assets 133 that may be linked based on sharing patterns 135. For example, an IP address may be linked between different accounts based on sending a chat message having the same pattern. Thus, relationship graphs 136 may provide a process for relating accounts and communications such that accounts and/or communications involved in the same or similar computing attack may be identified for computing attack mitigation and/or prevention.

At step 408, the communication is classified as to whether it is associated with a computing attack using a second AI model. Once ML models 138 are trained, ML models 138 may be deployed with one or more fraud detection and/or computing attack mitigation systems for detection and mitigation of computing attacks and other fraudulent behavior that may be perpetrated through communications 134. These may correspond to social engineering attacks, and as such, the communication and corresponding account data for the account sending the communication may be analyzed and correlated to other similar accounts and/or communications by ML models 138 and based on the created relationship graph. The relationship graph may allow for correlation to other accounts and communications for analysis of fraudulent activity or behavior associated with computing attacks. Thus, ML models 138 may utilize classifications 139 to classify the communication and/or account, which may use an attack classifier or the like to classify the communication as associated with or corresponding to a computing attack. In some embodiments, the attack classifier may utilize a score determined by ML models 138 and compare the score to a threshold score or requirement for attack classification by classifications 139.

At step 410, the communicate is routed to an endpoint or a fraud detection system based on a classification of the communication. Once ML models 138 are used to provide a classification and/or an inference of the communication, such as a risk or fraud score that may indicate the likelihood that an account is fraudulent or associated with fraudulent activity and/or a computing attack, communication routing 124 may route the communication appropriately. For example, if the communication is valid, the recipient user and/or endpoint may receive the communication, and no further action may be taken or required. However, if fraud or a computing attack is detected and/or classified for the communication, an automated attack mitigation and/or fraud prevention action, such as blocking a transaction, notifying a user, banning or blacklisting an account, or the like, may be performed. In some embodiments, communication routing 124 may include terminating the conversation or further communications, outputting an alert of the communication, and/or determining a trend associated with the communication and providing the trend with the alert and/or to a user or device endpoint for analysis.

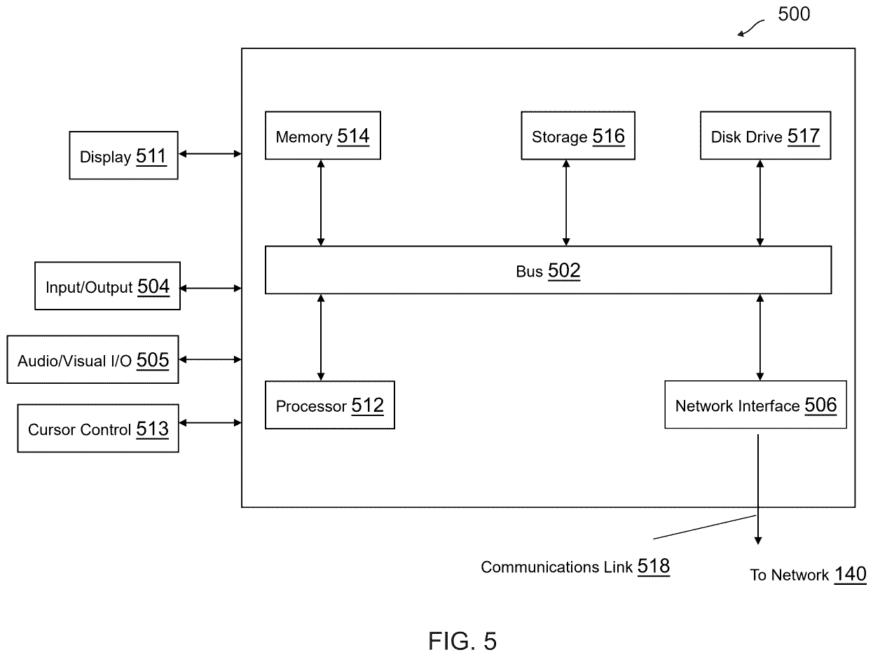

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a communication associated with a first account in a service assistance channel of a service provider, wherein the communication requests a response from an agent associated with the service assistance channel, and wherein the first account is associated with first account data;
extracting pattern data from the communication using a first artificial intelligence (AI) model of a deep learning pipeline;
determining a plurality of other accounts associated with the service provider and second account data for the plurality of other accounts, wherein the second account data includes previous communications associated with the plurality of other accounts;
generating a relationship graph for the first account and the plurality of other accounts based on the first account data, the second account data, and the pattern data, wherein the relationship graph identifies relationships between the first account and the plurality of other accounts based on shared assets from the first account data and the second account data and communication patterns for the communication and the previous communications;
classifying whether the communication is associated with a computing attack by a second AI model of the deep learning pipeline based on the relationship graph; and
routing the communication in the service assistance channel based on the classifying, wherein the routing includes determining whether to provide the communication to the agent for handling the response to the communication.

2. The method of claim 1, wherein the first AI model includes a natural language processing (NLP) parser, and wherein the extracting the pattern data comprises:
encoding content in the communication to encodings using the NLP parser; and
extracting at least one pattern in the content from the encodings and previous communication patterns.

3. The method of claim 2, wherein the first AI model comprises one of at least two AI models including the NLP parser and a large language model (LLM), wherein, prior to the encoding the content, the method further comprises:
summarizing the content using the LLM; and
extracting information from the summarized content using the LLM,
and wherein the NLP parser encodes the information from the content for the encodings.

4. The method of claim 1, wherein the second AI model comprises a machine learning (ML) classifier trained to classify whether different communications correspond to social engineering attacks, and wherein the classifying whether the communication is associated with the computing attack comprises classifying a similarity of the first account and the communication to one or more other accounts that performed one of more of the social engineering attacks.

5. The method of claim 1, wherein the routing comprises at least one of routing the communication to a recipient endpoint for the agent, terminating a conversation associated with the communication in the service assistance channel, or outputting at least one of an alert of the communication or a trend associated with the computing attack.

6. The method of claim 1, wherein the pattern data comprises at least one of a context or a purpose of the communication.

7. The method of claim 1, wherein the relationship graph includes a plurality of nodes corresponding to the first account, the plurality of other accounts, and asset identifiers from the first account data and the second account data, and wherein the relationship graph further includes a plurality of edges connecting the plurality of nodes based on sharing the shared assets or the communication patterns.

8. The method of claim 1, wherein, prior to the generating the relationship graph, the method further comprises:
extracting feature data for the relationship graph and the second AI model from the first account data and the second account data.

9. The method of claim 1, wherein the shared assets comprise data features for the first account and the plurality of other accounts, and wherein the data features include at least one of a computing device identifier, a network address, user information, or financial information.

10. A system comprising:
a non-transitory memory; and
one or more hardware processors coupled to the non-transitory memory and configured to execute instructions to cause the system to:
extract pattern data from a plurality of communications between a plurality of accounts;
access a relationship graph for the plurality of accounts that was generated based on account data for the plurality of accounts and the pattern data, wherein the relationship graph identifies relationships between the plurality of accounts based on shared assets from the account data and communication patterns for the plurality of communications;
classify a first account of the plurality of accounts as a potential fraudulent account, wherein the potential fraudulent account is predicted to engage in a computing attack via a subsequent communication; and
execute an identification challenge to the first account prior to the further communication and based on the classifying, wherein the identification challenge declassifies the first account as the potential fraudulent account if the identification challenge is satisfied.

11. The system of claim 10, wherein the pattern data is extracted based on semantic information from content in the plurality of communications.

12. The system of claim 11, wherein the instructions are further executable to cause the system to:
determine the semantic information using a natural language processing (NLP) parser associated with the first AI model, and wherein the NLP parser extracts and encodes the semantic information from the content.

13. The system of claim 10, wherein the instructions are further executable to cause the system to:
summarize the content using a large language model (LLM); and
extract key information based on the summarized content, wherein the pattern data is extracted based on the summarized content and the key information.

14. The system of claim 10, wherein the computing attack comprises a social engineering attack, and wherein the pattern data is associated with words or phrases used in at least one of a same context or a same purpose between the plurality of communications.

15. The system of claim 10, wherein the identification challenge comprises at least one of a challenge-response test to detect if the first account is used by a human user or a request for the human user to provide user verification data.

16. The system of claim 10, wherein the classifying the first account as the potential fraudulent account causes the subsequent communication to be routed to an endpoint associated with mitigating the computing attack.

17. The system of claim 10, wherein the relationship graph comprises nodes representing the shared assets connected by edges representing the communication patterns.

18. The system of claim 10, wherein the classifying the first account as the potential fraudulent account based on an attack classifier for at least two classifications associated with communications corresponding to the computing attack.

19. A non-transitory machine-readable medium having stored thereon machine-readable instructions executable to cause a machine to perform operations comprising:
receiving a communication from a first account in a service assistance channel of a service provider;
generating, by a first artificial intelligence (AI) model of a deep learning pipeline, a relationship graph for the first account and a second account based on first account data for the first account, second account data for the second account, and communications exchanged by the first account and the second account, wherein the relationship graph comprises shared assets from the first account data and the second account data connected based on patterns associated with the communications;
classifying whether the communication is associated with a computing attack by a second AI model of the deep learning pipeline based on the relationship graph; and
routing the communication in the service assistance channel based on the classifying.

20. The non-transitory machine-readable medium of claim 19, wherein the generating the relationship graph includes parsing content from the communication for at least one of the patterns.
